(19) United States
(12) Patent Application Publication
(10) Pub. No.: US 2008/0022365 A1
(43) Pub. Date: Jan. 24, 2008

(54) PORTABLE SECURITY TRANSMITTER AND SECURITY AUTHENTICATION SYSTEM USING THE SAME

(75) Inventors: Kyoung Soo Chae, Gyunggi-do (KR); Ghun Hahm, Seoul (KR); Hyun Joon Kim, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/780,137

(22) Filed: Jul. 19, 2007

(30) Foreign Application Priority Data
Jul. 20, 2006 (KR) 10-2006-68224

(51) Int. Cl. G06F 7/04; G06F 11/00

(52) U.S. Cl. 726/2; 726/26

(57) ABSTRACT

A security authentication system using a portable security transmitter including: an input unit for inputting a selection for beginning and end of a security mode and an operation in associated with the security mode; a first control unit controlling the security mode to be performed and controlling transmission of the security signal including a motion signal inputted after the security mode begins and unique authentication information, when the beginning of the security mode is inputted via the input unit; a motion sensor unit sensing a three-dimensional motion of a user and outputting the motion signal to the first control unit after the security mode begins according to the control of the first control unit; a wireless transmission unit wirelessly transmitting the security signal according to the control of the first control unit; and a display unit displaying operation state information according to the control of the first control unit.

### CROSS-REFERENCE TO RELATED APPLICATIONS

This application claims the priority of Korean Patent Application No. 2006-0068224 filed on Jul. 20, 2006, in the Korean Intellectual Property Office, the disclosure of which is incorporated herein by reference.

### BACKGROUND OF THE INVENTION

1. Field of the Invention

The present invention relates to a security authentication device using a portable terminal such as a mobile phone, and more particularly, to a portable security transmitter capable of simply performing a process for security authentication on a security device such as a wireless digital door lock and a security authentication system using the portable security transmitter.

2. Description of the Related Art

In general, portable terminals such as mobile phones perform predetermined specified functions. For example, mobile phones perform a telephony function and personal digital assistants (PDAs) perform a data communication function.

General mobile phones include an input unit for key input, a control unit controlling an operation caused by the key input via the input unit, a display unit displaying information according to the control of the control unit, and a telephone unit performing a conversation according to the control of the control unit.

However, though performing the telephony function, general mobile phones cannot recognize a motion on a mobile phone and cannot perform operations in association with the motion, such as a motion game.

### SUMMARY OF THE INVENTION

An aspect of the present invention provides a portable security transmitter and a security authentication system using the same, capable of simply performing a process of security authentication on a security device such as a wireless digital door lock by using a three-dimensional motion.

According to an aspect of the present invention, there is provided a portable security transmitter including: an input unit for inputting a selection for beginning and end of a security mode and an operation in associated with the security mode; a control unit controlling the security mode to be performed and controlling transmission of a security signal including a motion signal inputted after the security mode begins and unique authentication information, when the beginning of the security mode is inputted via the input unit; a motion sensor unit sensing a three-dimensional motion of a user and outputting the motion signal to the control unit after the security mode begins according to the control of the control unit; a wireless transmission unit wirelessly transmitting the security signal according to the control of the control unit; and a display unit displaying operation state information according to the control of the control unit.

According to another aspect of the present invention, there is provided a security authentication system including a portable security transmitter and a security receiver receiving a security signal from the portable security transmitter, the portable security transmitter including: an input unit for inputting a selection for beginning and end of a security mode and an operation in associated with the security mode; a first control unit controlling the security mode to be performed and controlling transmission of the security signal including a motion signal inputted after the security mode begins and unique authentication information, when the beginning of the security mode is inputted via the input unit; a motion sensor unit sensing a three-dimensional motion of a user and outputting the motion signal to the first control unit after the security mode begins according to the control of the first control unit; a wireless transmission unit wirelessly transmitting the security signal according to the control of the first control unit; and a display unit displaying operation state information according to the control of the first control unit, and the security receiver including: a wireless receiving unit receiving the security signal from the portable security transmitter; a second control unit comparing the motion signal included in the security signal from the wireless transmission unit with a preset reference motion signal, determining a success and a failure of security authentication based on a comparison result; and controlling maintenance and release of security based on a determination result; and a security drive unit performing the maintenance and release of security according to the control of the second control unit.

According to still another aspect of the present invention, there is provided a portable security transmitter including: an input unit for inputting a selection for beginning and end of a security mode and an operation in associated with the security mode; a control unit controlling the security mode to be performed, determining one of a success and a failure of security authentication by comparing an inputted motion signal with a preset reference motion signal, and controlling transmission of a security signal including a determination result signal and unique authentication information, when the beginning of the security mode is inputted via the input unit; a motion sensor unit sensing a 3-axis straight motion and a 3-axis rotating motion and outputting the sensed motions to the control unit according to the security mode executed by the control unit; a wireless transmission unit wirelessly transmitting the security signal according to the control of the control unit; and a display unit displaying operation state information according to the control of the control unit.

According to yet another aspect of the present invention, there is provided a security authentication system including a portable security transmitter and a security receiver receiving a security signal from the portable security transmitter, the portable security transmitter including: an input unit for inputting a selection for beginning and end of a security mode and an operation in associated with the security mode; a first control unit controlling the security mode to be performed, determining one of a success and a failure of security authentication by comparing an inputted motion signal with a preset reference motion signal, and controlling transmission of the security signal including a determination result signal and unique authentication information, when the beginning of the security mode is inputted via the input unit; a motion sensor unit sensing a 3-axis straight motion and a 3-axis rotating motion and outputting the sensed motions to the first control unit according to the security mode executed by the first control unit; a wireless transmission unit wirelessly transmitting the security signal according to the control of the first control unit; and a display unit displaying operation state information according to the control of the first control unit, and the security receiver including: a wireless receiving unit receiving the security signal from the portable security transmitter; a second control unit controlling maintenance and release of security according to whether the security authentication succeeds or fail, which is included in the security signal from the wireless transmission unit; and a security drive unit performing the maintenance and release of security according to the control of the second control unit.

The motion sensor unit may include: a 3-axis straight motion sensor part sensing a 3-axis straight motion; and a 3-axis rotation-motion sensor part sensing a 3-axis rotating motion.

The control unit may receive the motion signal from the motion sensor unit via the input unit during a preset amount of time from a point in time of the beginning of the security mode.

When setting up of the unique authentication information is selected via the input unit, after receiving and storing the unique authentication information in an internal memory, the control unit may receive new unique authentication information again via the input unit, may compare the new unique authentication information with the stored unique authentication information, and may set up the new unique authentication information as the unique authentication information when the new unique authentication information is identical to the stored unique authentication information.

When setting up of a reference motion is selected via the input unit, after sensing a motion via the motion sensor unit and storing the motion in an internal memory, the control unit may sense a new motion again via the motion sensor unit, may compare the new motion with the stored motion, and may set up the new motion as the reference motion when the new motion is identical to the stored motion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating a security authentication system according to an exemplary embodiment of the present invention;

FIGS. 2A through 2C are diagrams illustrating a trajectory of a motion;

FIGS. 3A and 3B are configuration diagrams illustrating a motion sensor unit shown in FIG. 1;

FIG. 4 is a graph illustrating an operation theory of the motion sensor unit shown in FIG. 1;

FIGS. 5A and 5B are flowcharts illustrating a security authentication method according to an embodiment of the present invention;

FIGS. 6A and 6B are flowcharts illustrating a security authentication method according to another embodiment of the present invention;

FIG. 7 is a flowchart illustrating a process of setting up unique authentication information according to an exemplary embodiment of the present invention; and

FIG. 8 is a flowchart illustrating a process of setting up a reference motion according to an exemplary embodiment of the present invention.

### DETAILED DESCRIPTION OF THE PREFERRED EMBODIMENT

Hereinafter, the present invention will be described in detail by explaining preferred embodiments of the invention with reference to the attached drawings. Like reference numerals in the drawings denote like elements.

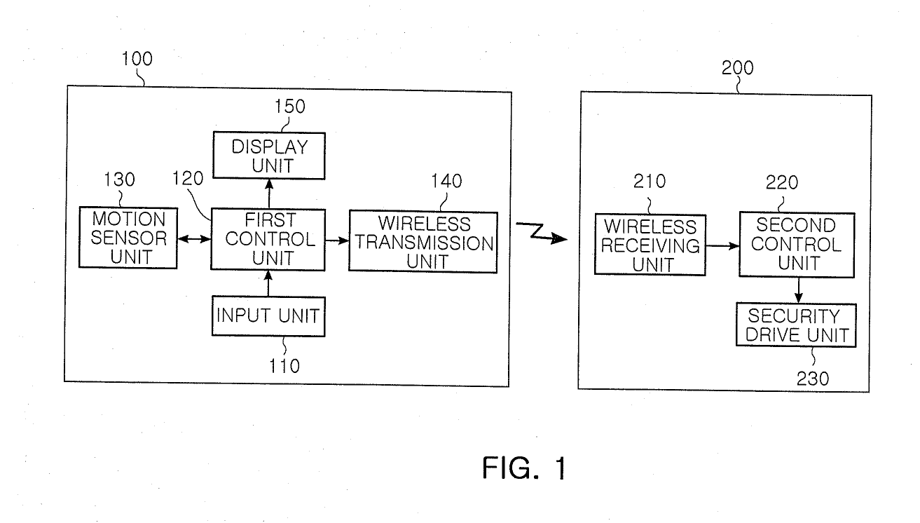

FIG. 1 is a configuration diagram illustrating a security authentication system according to an exemplary embodiment of the present invention.

Referring to FIG. 1, the security authentication system includes a portable security transmitter 100 and a security receiver 200 receiving a security signal from the portable security transmitter.

The portable security transmitter 100 will be described via two embodiments, and each embodiment of the security receiver 200, which corresponds to each of the two embodiments of the portable security transmitter, will be described.

According to an embodiment of the present invention, the portable security transmitter 100 includes an input unit 110 for inputting a selection for beginning and end of a security mode and an operation in associated with the security mode; a first control unit 120 controlling the security mode to be performed and controlling transmission of the security signal including a motion signal inputted after the security mode begins and unique authentication information, when the beginning of the security mode is inputted via the input unit 110; a motion sensor unit 130 sensing a three-dimensional motion of a user and outputting the motion signal to the first control unit 120 after the security mode begins according to the control of the first control unit 120; a wireless transmission unit 140 wirelessly transmitting the security signal according to the control of the first control unit 120; and a display unit 150 displaying operation state information according to the control of the first control unit 120.

In association with the portable security transmitter 100 according to an embodiment of the present invention, the security receiver 200 includes: a wireless receiving unit 210 receiving the security signal from the portable security transmitter; a second control unit 220 comparing the motion signal included in the security signal from the wireless transmission unit 140 with a preset reference motion signal, determining a success and a failure of security authentication based on a comparison result; and controlling maintenance and release of security based on a determination result; and a security drive unit 230 performing the maintenance and release of security according to the control of the second control unit 220.

According to another embodiment of the present invention, the portable security transmitter 100 includes: an input unit 110 for inputting a selection for beginning and end of a security mode and an operation in associated with the security mode; a first control unit 120 controlling the security mode to be performed, determining one of a success and a failure of security authentication by comparing an inputted motion signal with a preset reference motion signal, and controlling transmission of the security signal including a determination result signal and unique authentication information, when the beginning of the security mode is inputted via the input unit 110; a motion sensor unit 130 sensing a 3-axis straight motion and a 3-axis rotating motion and outputting the sensed motions to the first control unit 120 according to the security mode executed by the first control unit 120; a wireless transmission unit 140 wirelessly transmitting the security signal according to the control of the first control unit 120; and a display unit 150 displaying operation state information according to the control of the first control unit 120.

In association with the portable security transmitter 100 according to another embodiment of the present invention, the security receiver 200 includes: a wireless receiving unit 210 receiving the security signal from the portable security transmitter; a second control unit 220 controlling maintenance and release of security according to whether the security authentication succeeds or fail, which is included in the security signal from the wireless transmission unit 140; and a security drive unit 230 performing the maintenance and release of security according to the control of the second control unit 220.

On the other hand, the first control unit 120 may receive the motion signal from the motion sensor unit 130 via the input unit 110 during a preset amount of time from a point in time of the beginning of the security mode.

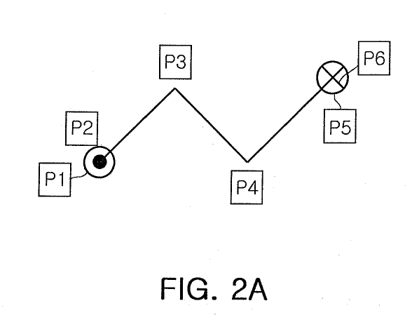

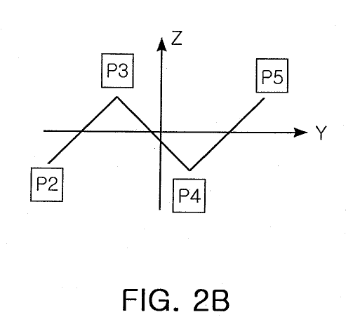

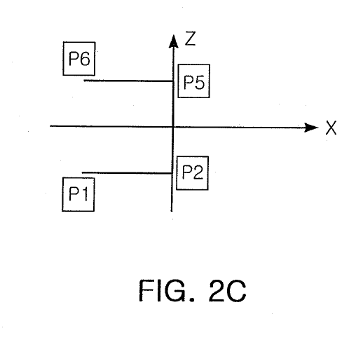

FIGS. 2A through 2C are diagrams illustrating a trajectory of a motion.

Referring to FIG. 2A, the motion may be formed of a motion trajectory from P1 through P6. FIG. 2B is a front view illustrating the motion in FIG. 2A, and FIG. 2C is a side view illustrating the motion in FIG. 2A.

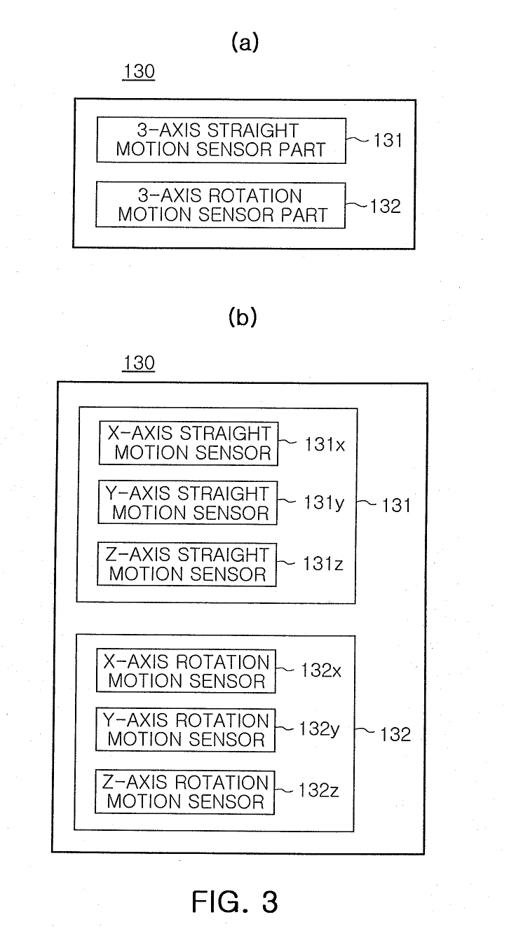

FIGS. 3A and 3B are configuration diagrams illustrating the motion sensor unit 130 of FIG. 1.

Referring to FIG. 3A, the motion sensor unit 130 includes a 3-axis straight motion sensor part 131 sensing a 3-axis straight motion; and a 3-axis rotation-motion sensor part 132 sensing a 3-axis rotating motion.

Referring to FIG. 2B, the 3-axis straight motion sensor part 131 includes an X-axis straight motion sensor 131x sensing a straight motion about a certain X-axis, an Y-axis straight motion sensor 131y sensing a straight motion about an Y-axis perpendicular to the X-axis, and a Z-axis straight motion sensor 131z sensing a straight motion about a Z axis perpendicular to the X-axis and the Y-axis, respectively.

Also, the 3-axis rotation-motion sensor part 132 includes an X-axis rotation-motion sensor 132x sensing a rotating motion about a certain X-axis, an Y-axis rotation-motion sensor 132y sensing a rotating motion about an Y-axis perpendicular to the X-axis, and a Z-axis rotation-motion sensor 132z sensing a rotating motion about a Z axis perpendicular to the X-axis and the Y-axis, respectively.

For example, the 3-axis straight motion sensor part 131 may be embodied as an acceleration sensor capable of detecting a physical quantity of acceleration and the 3-axis rotation-motion sensor part 132 may be an inertia sensor such as a gyro sensor capable of detecting rotation acceleration.

In this case, the acceleration sensor is a sensor converting the physical quantity of acceleration into an electrical signal and may correspond to one of an electrostatic sensor, a piezoelectric sensor, and a thermal sensor, depending on a conversion form thereof. In this case, the electrostatic sensor converts an amount of a change in electrostatic capacity caused by applied acceleration, the piezoelectric sensor converts an amount of a resistance change of a resistor into a voltage, and the thermal sensor converts and outputs an amount of a change in thermal distribution into a voltage.

Also, the gyro sensor is a sensor converting a rotation angular velocity into an electrical signal. The gyro sensor converts an amount of a change in electrostatic capacity caused by a change of an applied rotation angular velocity into a voltage signal and outputs the voltage signal.

Accordingly, the acceleration sensor is used as a sensor for sensing a straight motion and the gyro sensor is used as a sensor for sensing a rotating motion. When a game is performed by using a 3-axis acceleration sensor and a 3-axis gyro sensor, it may be possible to recognize a straight motion, right and left movements, and a rotation.

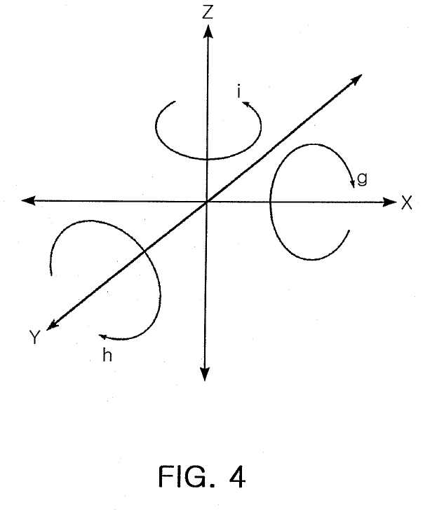

FIG. 4 is a graph illustrating an operation theory of the motion sensor unit 130 shown in FIG. 1.

Referring to FIG. 4, a horizontal axis is an X-axis, a vertical axis is an Y-axis, and an axis from a upper right side to a lower left side is a Z-axis perpendicular to the X-axis and Y-axis, respectively. In this case, “g” indicates a rotating motion about the X-axis, “h” indicates a rotating motion about the Y-axis, and “i” indicates a rotating motion about the Z-axis.

The portable security transmitter as described above may be applied to card authorization of card authorizers, admission of a door lock, and access authentication for websites.

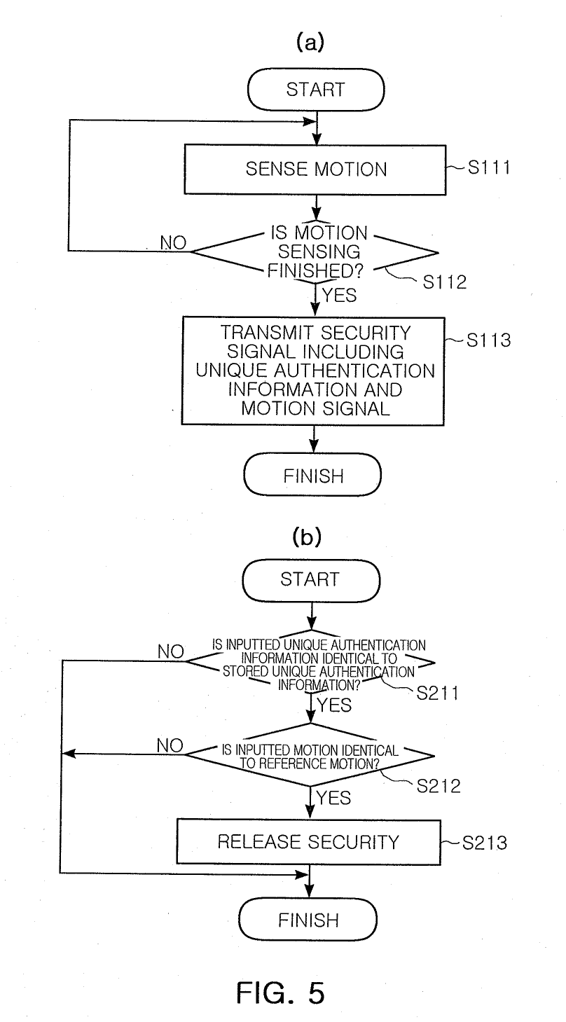

FIGS. 5A and 5B are flowcharts illustrating a security authentication method according to an embodiment of the present invention.

Referring to FIG. 5A, a motion is sensed (S111), it is determined whether motion sensing is finished (S112), and a security signal including unique authentication information and a motion signal is transmitted (S113).

Referring to FIG. 5B, the received unique authentication information is compared with preset unique authentication information (S211), the received motion is compared with a reference motion (S212), and one of maintenance and release of security is performed according to a comparison result (S213).

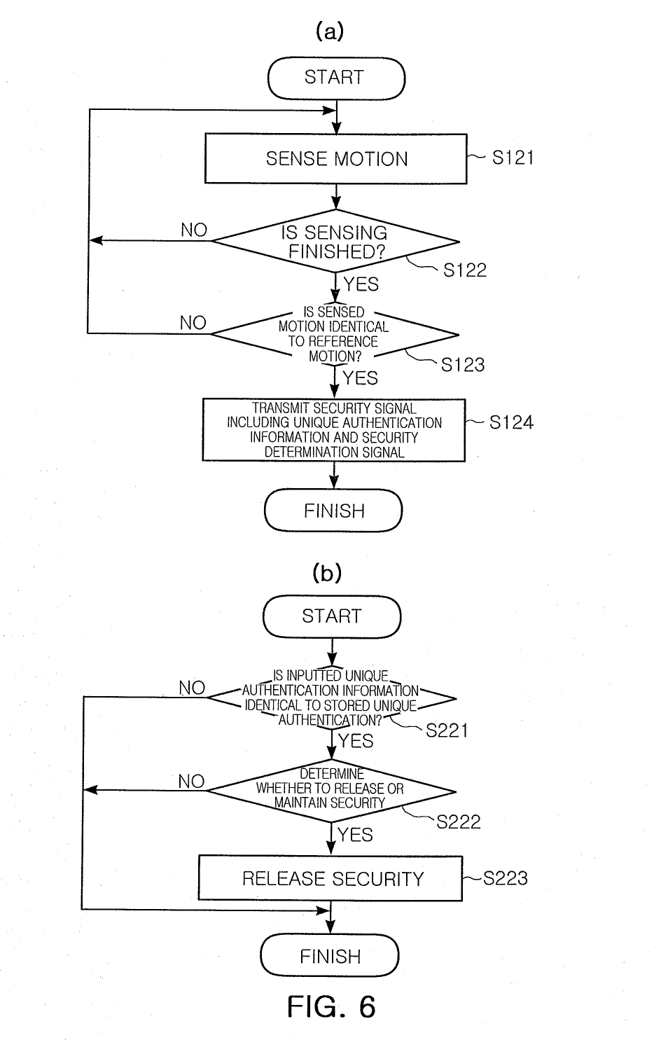

FIGS. 6A and 6B are flowcharts illustrating a security authentication method according to another embodiment of the present invention.

Referring to FIG. 6A, a motion is sensed (S121), it is determined whether motion sensing is finished (S122), the sensed motion is compared with a reference motion (S123), and a security signal including unique authentication information and one of security maintenance information and security release information according to a comparison result is transmitted (S124).

Referring to FIG. 6B, the received unique authentication information is compared with preset unique authentication information (S221), it is determined whether security is maintained or released (S222), and one of security maintenance and security release is performed according to a determination result.

Also, When setting up of the unique authentication information is selected via the input unit 110, after receiving and storing the unique authentication information in an internal memory, the first control unit 120 may receive new unique authentication information again via the input unit 110, may compare the new unique authentication information with the stored unique authentication information, and may set up the new unique authentication information as the unique authentication information when the new unique authentication information is identical to the stored unique authentication information.

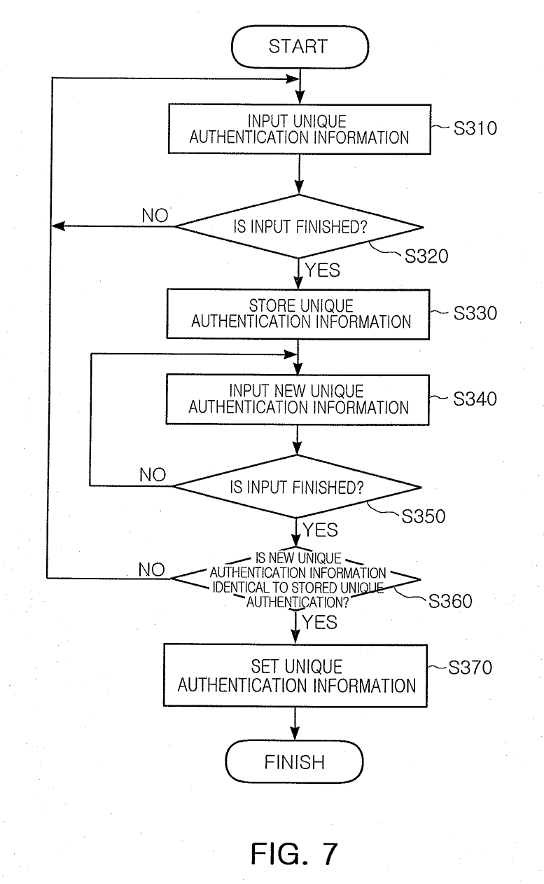

FIG. 7 is a flowchart illustrating a process of setting up unique authentication information according to an exemplary embodiment of the present invention.

Referring to FIG. 7, unique authentication information is inputted (S310), it is determined whether the input of unique authentication information is finished (S320), the unique authentication information is stored in an internal memory (S330), new unique authentication information is inputted (S340), it is determined whether the input of unique authentication information is finished (S350), the stored unique authentication information is compared with the new unique authentication information (S360), and the new unique authentication information is set as the unique authentication information (S370).

When setting up of a reference motion is selected via the input unit 110, after sensing a motion via the motion sensor unit 110 and storing the motion in an internal memory, the first control unit 120 may sense a new motion again via the motion sensor unit, may compare the new motion with the stored motion, and may set up the new motion as the reference motion when the new motion is identical to the stored motion.

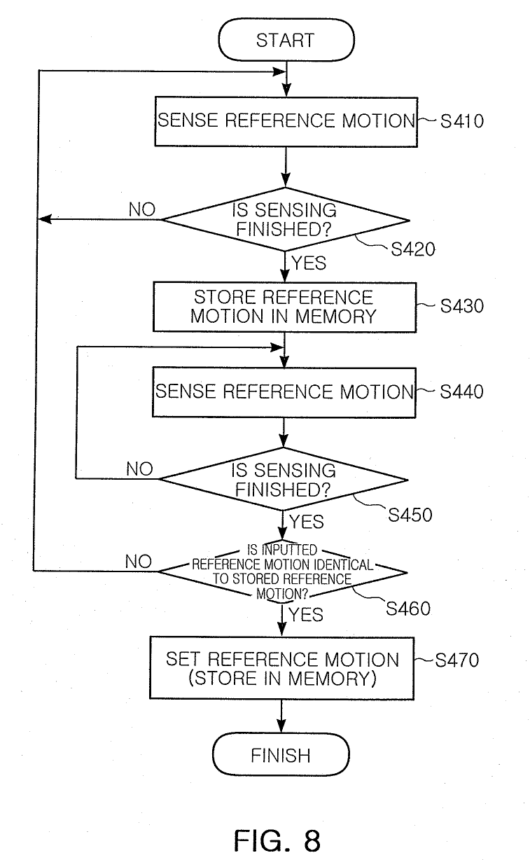

FIG. 8 is a flowchart illustrating a process of setting up a reference motion according to an exemplary embodiment of the present invention.

Referring to FIG. 8, a reference motion is sensed (S410), it is determined whether reference motion sensing is finished (S420), the reference motion is stored (S430), a new reference motion is inputted (S440), it is determined whether the input of the new reference motion is finished (S450), the stored reference motion is compared with the new reference motion (S460), and the new reference motion is set as the reference motion (S470).

Hereinafter, operations and effects of the present invention will be described in detail with reference to the attached drawings.

Referring to FIG. 1, the portable security transmitter of the security authentication system according to an exemplary embodiment of the present invention wirelessly transmits a security signal based on a motion to the security receiver and the security receiver releases security when the motion is identical to a reference motion.

A motion according to an exemplary embodiment of the present invention corresponds to a three-dimensional trajectory corresponding to a three-dimensional motion. Accordingly, the motion may be variously distinguished. An example of the motion will be described with reference to FIGS. 2A through 2C.

Referring to FIGS. 2A, 2B, and 2C, the motion may be formed of a motion trajectory from P1 through P6. In this case, FIG. 2B is a front view illustrating the motion in FIG. 2A, and FIG. 2C is a side view illustrating the motion in FIG. 2A.

The portable security transmitter 100 includes the input unit 110, the first control unit 120, the motion sensor unit 130, the wireless transmitter 140, and the display unit 150. The motion sensor unit 130 will be described in detail with reference to FIGS. 3A, 3B and 4.

Referring to FIGS. 3A, 3B and 4, operations of the motion sensor unit 130 will be described in detail.

Referring to FIG. 3A, the motion sensor unit 130 includes the 3-axis straight motion sensor part 131 and the 3-axis rotation motion sensor part 132.

Referring to FIG. 3B, the 3-axis straight motion sensor part 131 includes the X-axis straight motion sensor 131x, the Y-axis straight motion sensor 131y, and the Z-axis straight motion sensor 131z and the 3-axis rotation motion sensor part 132 includes the X-axis rotation motion sensor 132x, the Y-axis rotation motion sensor 132y, and the Z-axis rotation motion sensor 132z.

The X-axis straight motion sensor 131x senses a straight motion about a certain X-axis, the Y-axis straight motion sensor 131y senses a straight motion about an Y-axis perpendicular to the X-axis, and the Z-axis straight motion sensor 131z senses a straight motion about a Z axis perpendicular to the X-axis and the Y-axis.

As described above, the 3-axis straight motion sensor part 131 senses straight motions about each of the X-axis, Y-axis, and Z-axis, respectively, and transmits a sensing signal of a 3-axis straight motion to the wireless transmission unit 140.

A method of using the 3-axis straight motion sensor part 131 will be described.

Referring to FIG. 4, a sense directions of one of swing and tilting of the portable security transmitter 100 is determined to be top and bottom, right and left, and front and rear. Direction vectors are set as x, y, and z, which are natural number not less than 1, respectively. When numbers of swing and tilting sensed for each sense direction of top and bottom, right and left, and front and rear are a, b, c, respectively, a direction value and size of the x, y, and z may be shown as Equation 1.

X=ax, Y=by, Z=cz Equation 1

In Equation 1, since X, Y, and Z indicate a motion amount and direction of an object, a combination of X, Y, and Z may be used to determine a motion direction while playing a game. For example, when applied to a door lock, the combination may be used to release security by using a three-dimensional motion of a user.

Also, the 3-axis rotation motion sensor part 132 senses a rotation motion about each of the X-axis, Y-axis, and Z-axis and transmits a sensing signal to the wireless transmission unit 140.

As described above, a movement for the rotation may be sensed by applying the 3-axis rotation motion sensor part 132 by using a gyro sensor capable of recognizing a rotation angular velocity.

When rotation directions are defined as g, h, and i and rotation amounts of the directions are defined as d, e, and f, respectively, direction values and sizes may be shown as follows.

X=ax, Y=by, Z=cz, G=dg, H=eh, I=fi Equation 2

A combination as shown in Equation 2 may be used to set a motion direction while playing a game, similar to a case of using only an acceleration sensor.

Hereinafter, the portable security transmitter 100 will be described via two embodiments, and each embodiment of the security receiver 200, which corresponds to each of the two embodiments of the portable security transmitter, will be described referring to FIGS. 5A, 5B, 6A and 6B.

Referring to FIGS. 5A and 5B, the portable security transmitter 100 according to an embodiment of the present invention will be described.

Referring to FIG. 5A, the first control unit 120 performs a security mode when a beginning of the security mode is inputted via the input unit 110.

In this case, after the security mode begins according to the control of the first control unit 120, the motion sensor unit 130 senses a three-dimensional motion of a user by performing the operation as described above and transmits a motion signal to the first control unit 120 (S111 and S112).

In this case, the first control unit 120 controls the wireless transmission unit 140 to transmit a security signal including the motion signal inputted after the security mode begins and unique authentication information. In this case, the first control unit 120 may receive the motion signal from the motion sensor unit 130 during a preset amount of time from a point in time of the beginning of the security mode.

Accordingly, the wireless transmission unit 140 wirelessly transmits the security signal according to the control of the first control unit 120 (S113).

The display unit 150 displays operation state information according to the control of the first control unit 120.

Referring to FIG. 5B, operations of the security receiver 200 will be described with respect to the portable security transmitter 100.

Referring to FIG. 5B, the wireless receiving unit 210 of the security receiver 200 receives and outputs a security signal from the portable security transmitter 100 to the second control unit 220. The second control unit 220 compares unique authentication information included in the security signal from the wireless receiving unit 210 with preset unique authentication information (S211). In this case, when the received unique authentication information is identical to the preset unique authentication information, the second control unit 220 compares a motion signal included in the security signal from the wireless receiving unit 210 with a preset reference motion signal and determines whether security authentication succeeds or fail, according to a comparison result (S212), and controls the security drive unit 230 to maintain or release security according to a determination result. Accordingly, the security drive unit 230 performs one of maintenance and release of the security according to the control of the second control unit 220.

Referring to FIGS. 6A and 6B, the portable security transmitter 100 according to another embodiment of the present invention will be described.

Referring to FIG. 6A, the first control unit 120 of the portable security transmitter 100 controls a security mode to be performed when a beginning of the security mode is inputted via the input unit 110.

In this case, according to the security mode performed by the motion sensor unit 130, the motion sensor unit 130 senses and transmits a 3-axis straight motion and a 3-axis rotation motion to the first control unit 120 (S121 and S122).

Accordingly, the first control unit 120 determines whether security authentication succeeds or fail by comparing a motion signal inputted from the motion sensor unit 130 with a preset reference motion signal (S123) and controls the wireless transmission unit 140 to transmit a security signal including a determination result signal and unique authentication information (S124). In this case, the first control unit 120 may receive the motion signal from the motion sensor unit 130 during a preset amount of time from a point in time of the beginning of the security mode.

Accordingly, the wireless transmission unit 140 wirelessly transmits the security signal according to the control of the first control unit 120.

The display unit 150 displays operation state information according to the control of the first control unit 120.

Referring to FIG. 6B, operations of the security receiver 200 will be described with respect to the portable security transmitter 100.

Referring to FIG. 6B, the wireless receiving unit 210 of the security receiver 200 receives and outputs a security signal from the portable security transmitter 100 to the second control unit 220. The second control unit 220 compares unique authentication information included in the security signal from the wireless receiving unit 210 with preset unique authentication information (S221). In this case, when the received unique authentication information is identical to the preset unique authentication information, the second control unit 220 controls the security mode to be maintained or released according to the determination result included in the security signal from the wireless receiving unit 210 (S222).

In this case, the security drive unit 230 performs one of maintenance and release of the security according to the control of the second control unit 220 (S223).

The security authentication system according to an exemplary embodiment of the present invention may be applied to card authorization of card authorizers, admission of a door lock, and access authentication for websites.

The security authentication system may set unique authentication information and a reference motion desired by a user according to the selection of the user, which will be described referring to FIGS. 7 and 8.

Referring to FIG. 7, in the portable security transmitter 100, setting of unique authentication information is selected and the unique authentication information is inputted via the input unit 110 (S310), the setting of the unique authentication information is finished (S320), the first control unit 120 stores the unique authentication information inputted via the input unit 110 in an internal memory (S330).

After this, as a process of receiving and recognizing new unique authentication information, the first control unit 120 receives the new unique authentication information via the operations described above (S340), the input of the new unique authentication information via the input unit 110 is finished (S350), and the first control unit 120 compares the stored unique authentication information with the inputted unique authentication information (S360) and sets the unique authentication information when the stored unique authentication information is identical to the inputted unique authentication information (S370).

Referring to FIG. 8, in the portable security transmitter 100, setting of a reference motion is selected via the input unit 110, a user moves the portable security transmitter 100, a motion corresponding to a movement of the portable security transmitter 100 is sensed and outputted to the first control unit 120 by the motion sensor unit 130 (S410).

When the input of the reference motion is finished via the input unit 110 (S420), the first control unit 120 stores the motion sensed by the motion sensor unit 130 as a reference motion in an internal memory (S430).

After this, as a process of receiving and recognizing a new reference motion, the first control unit 120 senses the new motion via the operations described above (S440), the input of the new motion is finished via the input unit (S450), and the first control unit 120 compares the motion sensed by the motion sensor unit 130 with the stored reference motion (S460) and sets the reference motion when the motion sensed by the motion sensor unit 130 is identical to the stored reference motion (S470).

As described above, according to the present invention, security authentication is performed by using a three-dimensional motion, thereby more simply performing a process of security authentication of security devices such as wireless digital door locks.

While the present invention has been shown and described in connection with the exemplary embodiments, it will be apparent to those skilled in the art that modifications and variations can be made without departing from the spirit and scope of the invention as defined by the appended claims.

What is claimed is:

1. A portable security transmitter comprising:
an input unit for inputting a selection for beginning and end of a security mode and an operation in associated with the security mode;
a control unit controlling the security mode to be performed and controlling transmission of a security signal including a motion signal inputted after the security mode begins and unique authentication information, when the beginning of the security mode is inputted via the input unit;
a motion sensor unit sensing a three-dimensional motion of a user and outputting the motion signal to the control unit after the security mode begins according to the control of the control unit;
a wireless transmission unit wirelessly transmitting the security signal according to the control of the control unit; and
a display unit displaying operation state information according to the control of the control unit.

2. The transmitter of claim 1, wherein the motion sensor unit comprises:
a 3-axis straight motion sensor part sensing a 3-axis straight motion; and
a 3-axis rotation-motion sensor part sensing a 3-axis rotating motion.

3. The transmitter of claim 1, wherein the control unit receives the motion signal from the motion sensor unit via the input unit during a preset amount of time from a point in time of the beginning of the security mode.

4. The transmitter of claim 1, wherein, when setting up of the unique authentication information is selected via the input unit, after receiving and storing the unique authentication information in an internal memory, the control unit receives new unique authentication information again via the input unit, compares the new unique authentication information with the stored unique authentication information, and sets up the new unique authentication information as the unique authentication information when the new unique authentication information is identical to the stored unique authentication information.

5. The transmitter of claim 1, wherein, when setting up of a reference motion is selected via the input unit, after sensing a motion via the motion sensor unit and storing the motion in an internal memory, the control unit senses a new motion again via the motion sensor unit, compares the new motion with the stored motion, and sets up the new motion as the reference motion when the new motion is identical to the stored motion.

6. A security authentication system comprising a portable security transmitter and a security receiver receiving a security signal from the portable security transmitter, the portable security transmitter comprising:
an input unit for inputting a selection for beginning and end of a security mode and an operation in associated with the security mode;
a first control unit controlling the security mode to be performed and controlling transmission of the security signal including a motion signal inputted after the security mode begins and unique authentication information, when the beginning of the security mode is inputted via the input unit;
a motion sensor unit sensing a three-dimensional motion of a user and outputting the motion signal to the first control unit after the security mode begins according to the control of the first control unit;
a wireless transmission unit wirelessly transmitting the security signal according to the control of the first control unit; and
a display unit displaying operation state information according to the control of the first control unit, and
the security receiver comprising:
a wireless receiving unit receiving the security signal from the portable security transmitter;
a second control unit comparing the motion signal included in the security signal from the wireless transmission unit with a preset reference motion signal, determining a success and a failure of security authentication based on a comparison result; and controlling maintenance and release of security based on a determination result; and
a security drive unit performing the maintenance and release of security according to the control of the second control unit.

7. The system of claim 6, wherein the motion sensor unit comprises:
a 3-axis straight motion sensor part sensing a 3-axis straight motion; and
a 3-axis rotation-motion sensor part sensing a 3-axis rotating motion.

8. The system of claim 6, wherein the first control unit receives the motion signal from the motion sensor unit via the input unit during a preset amount of time from a point in time of the beginning of the security mode.

9. The system of claim 6, wherein, when setting up of the unique authentication information is selected via the input unit, after receiving and storing unique authentication information in an internal memory, the first control unit receives new unique authentication information again via the input unit, compares the new unique authentication information with the stored unique authentication information, and sets up the new unique authentication information as the unique authentication information when the new unique authentication information is identical to the stored unique authentication information.

10. The system of claim 6, wherein, when setting up of a reference motion is selected via the input unit, after sensing a motion via the motion sensor unit and storing the motion in an internal memory, the first control unit senses a new motion again via the motion sensor unit, compares the new motion with the stored motion, and sets up the new motion as the reference motion when the new motion is identical to the stored motion.

11. A portable security transmitter comprising:
an input unit for inputting a selection for beginning and end of a security mode and an operation in associated with the security mode;
a control unit controlling the security mode to be performed, determining one of a success and a failure of security authentication by comparing an inputted motion signal with a preset reference motion signal, and controlling transmission of a security signal including a determination result signal and unique authentication information, when the beginning of the security mode is inputted via the input unit;
a motion sensor unit sensing a 3-axis straight motion and a 3-axis rotating motion and outputting the sensed motions to the control unit according to the security mode executed by the control unit;
a wireless transmission unit wirelessly transmitting the security signal according to the control of the control unit; and
a display unit displaying operation state information according to the control of the control unit.

12. The transmitter of claim 11, wherein the motion sensor unit comprises
a 3-axis straight motion sensor part sensing the 3-axis straight motion; and
a 3-axis rotation-motion sensor part sensing the 3-axis rotating motion.

13. The transmitter of claim 11, wherein the control unit receives the motion signal from the motion sensor unit via the input unit during a preset amount of time from a point in time of the beginning of the security mode.

14. The transmitter of claim 11, wherein, when setting up of the unique authentication information is selected via the input unit, after receiving and storing unique authentication information in an internal memory, the control unit receives new unique authentication information again via the input unit, compares the new unique authentication information with the stored unique authentication information, and sets up the new unique authentication information as the unique authentication information when the new unique authentication information is identical to the stored unique authentication information.

15. The transmitter of claim 11, wherein, when setting up of a reference motion is selected via the input unit, after sensing a motion via the motion sensor unit and storing the motion in an internal memory, the control unit senses a new motion again via the motion sensor unit, compares the new motion with the stored motion, and sets up the new motion as the reference motion when the new motion is identical to the stored motion.

16. A security authentication system comprising a portable security transmitter and a security receiver receiving a security signal from the portable security transmitter, the portable security transmitter comprising:
an input unit for inputting a selection for beginning and end of a security mode and an operation in associated with the security mode;
a first control unit controlling the security mode to be performed, determining one of a success and a failure of security authentication by comparing an inputted motion signal with a preset reference motion signal, and controlling transmission of the security signal including a determination result signal and unique authentication information, when the beginning of the security mode is inputted via the input unit;
a motion sensor unit sensing a 3-axis straight motion and a 3-axis rotating motion and outputting the sensed motions to the first control unit according to the security mode executed by the first control unit;
a wireless transmission unit wirelessly transmitting the security signal according to the control of the first control unit; and
a display unit displaying operation state information according to the control of the first control unit, and
the security receiver comprising:
a wireless receiving unit receiving the security signal from the portable security transmitter;
a second control unit controlling maintenance and release of security according to whether the security authentication succeeds or fail, which is included in the security signal from the wireless transmission unit; and
a security drive unit performing the maintenance and release of security according to the control of the second control unit.

17. The transmitter of claim 16, wherein the motion sensor unit comprises:
a 3-axis straight motion sensor part sensing a 3-axis straight motion; and
a 3-axis rotation-motion sensor part sensing a 3-axis rotating motion.

18. The system of claim 16, wherein the first control unit receives the motion signal from the motion sensor unit via the input unit during a preset amount of time from a point in time of the beginning of the security mode.

19. The system of claim 16, wherein, when setting up of the unique authentication information is selected via the input unit, after receiving and storing unique authentication information in an internal memory, the first control unit receives new unique authentication information again via the input unit, compares the new unique authentication information with the stored unique authentication information, and sets up the new unique authentication information as the unique authentication information when the new unique authentication information is identical to the stored unique authentication information.

20. The system of claim 16, wherein, when setting up of a reference motion is selected via the input unit, after sensing a motion via the motion sensor unit and storing the motion in an internal memory, the first control unit senses a new motion again via the motion sensor unit, compares the new motion with the stored motion, and sets up the new motion as the reference motion when the new motion is identical to the stored motion.
